(19) United States
(12) Patent Application Publication
(10) Pub. No.: US 2004/0226199 A1
(43) Pub. Date: Nov. 18, 2004

(54) Extended license plate holder

(76) Inventor: Sean R. MacDonald, Inverness, FL (US)

Correspondence Address: Sean R. MacDonald, 1616 Dickinson Street, Inverness, FL, 34450, US

(21) Appl. No.: 10/795,490

(22) Filed: Mar. 8, 2004

Related U.S. Application Data
(60) Provisional application No. 60/454,685, filed on Mar. 17, 2003.

(51) Int. Cl. G09F 7/00

(52) U.S. Cl. 40/209

(57) ABSTRACT

Vehicles are designed with a space for a license plate. Some vehicles are designed with a space larger than needed for a license plate with any associated frames or currently available holders. My idea is a license plate attachment that would utilize some or all of the unused space for, but not limited to, words; phrases; icons; images; logos; affiliations; designs; scrollwork; electronics; and other custom designs or decorations. The attachment would be permanently or temporarily attached by mechanical, magnetic or other means, thereby providing a mounting platform for the existing plate or by simply framing the traditionally mounted plate. The attachment would be constructed of, but not limited to, various metals and or plastics.

### CROSS REFERENCE TO RELATED APPLICATIONS

This application claims priority from provisional application No. 60/454,685 with a filing date of Mar. 17, 2003.

### STATEMENT REGARDING FED SPONSORED R & D

Not applicable

### REFERENCE TO SEQUENCE LISTING, A TABLE OR A COMPUTER PROGRAM

Not applicable

### BACKGROUND OF THE INVENTION

My invention is in the automotive field, primarily in the U.S. patent classification 40/209 as it relates to the license plate frames. License plate frames are currently limited in size and do not take advantage of the extended license plate opening featured on many vehicle makes and models.

A search of the prior art did not disclose any patents that read directly on the claims of the instant invention. However, the following U.S. patent numbers were considered related.

| Patent Number | Inventor | Issued |
|---|---|---|
| U.S. Pat. No. 6,533,695B1 | Wang | Apr. 29, 2003 |
| U.S. Pat. No. 6,243,977B1 | Shuen | Jun. 12, 2001 |
| U.S. Pat. No. 6,570,674B2 | Pleotis | May 27, 2003 |
| U.S. Pat. No. 6,550,166B1 | Lyon | Apr. 22, 2003 |

### BRIEF SUMMARY OF INVENTION

My invention is an extended automotive license plate holder designed to give various users more room for decoration.

### BRIEF DESCRIPTION OF THE DRAWINGS (IF FILED)

FIG. 1 is a view of an extended plate mount area,

FIG. 2 is a view thereof with a license plate attached illustrating a substantial unused area,

FIG. 3 is a view thereof with the present invention and a license plate affixed,

FIG. 4 is a view thereof with the present invention affixed atop a license plate.

### DETAILED DESCRIPTION

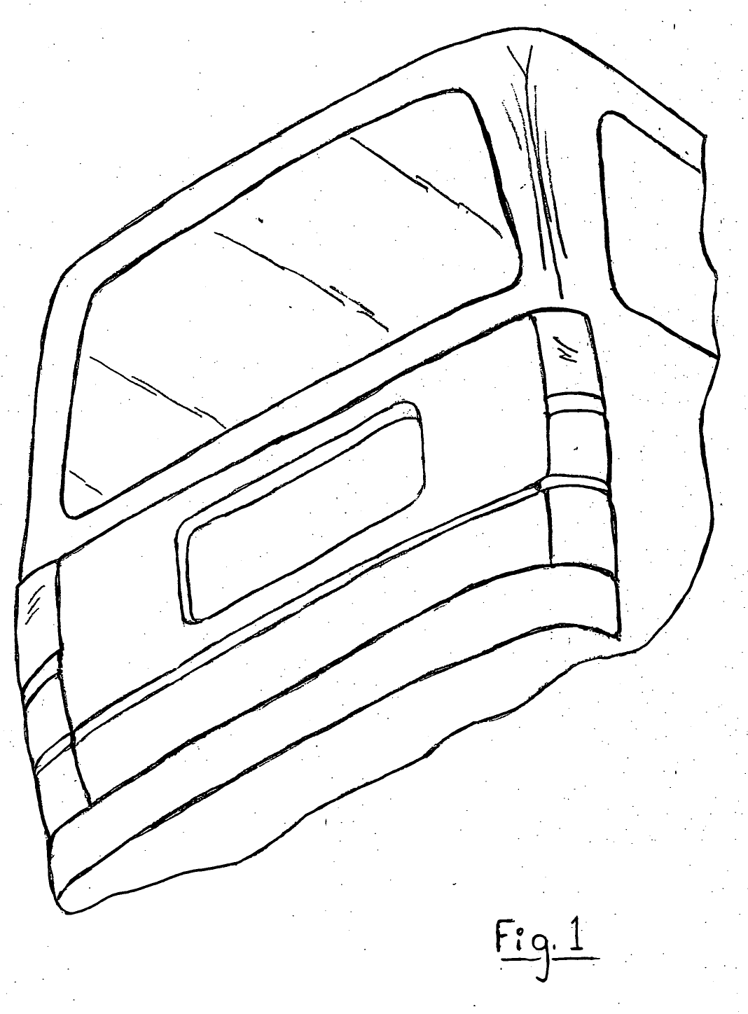

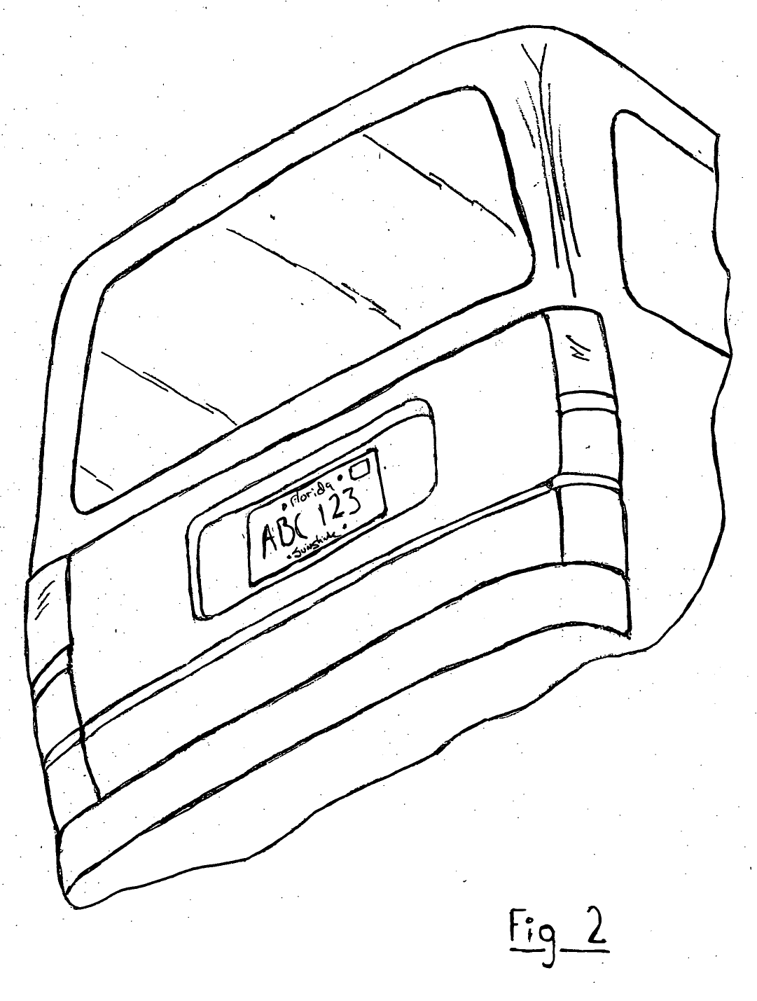

Vehicles are designed with a space for a license plate. Some vehicle makes and models are designed with a space larger than needed for a license plate (see FIG. 1) including any affixed frames or holders (see FIG. 2).

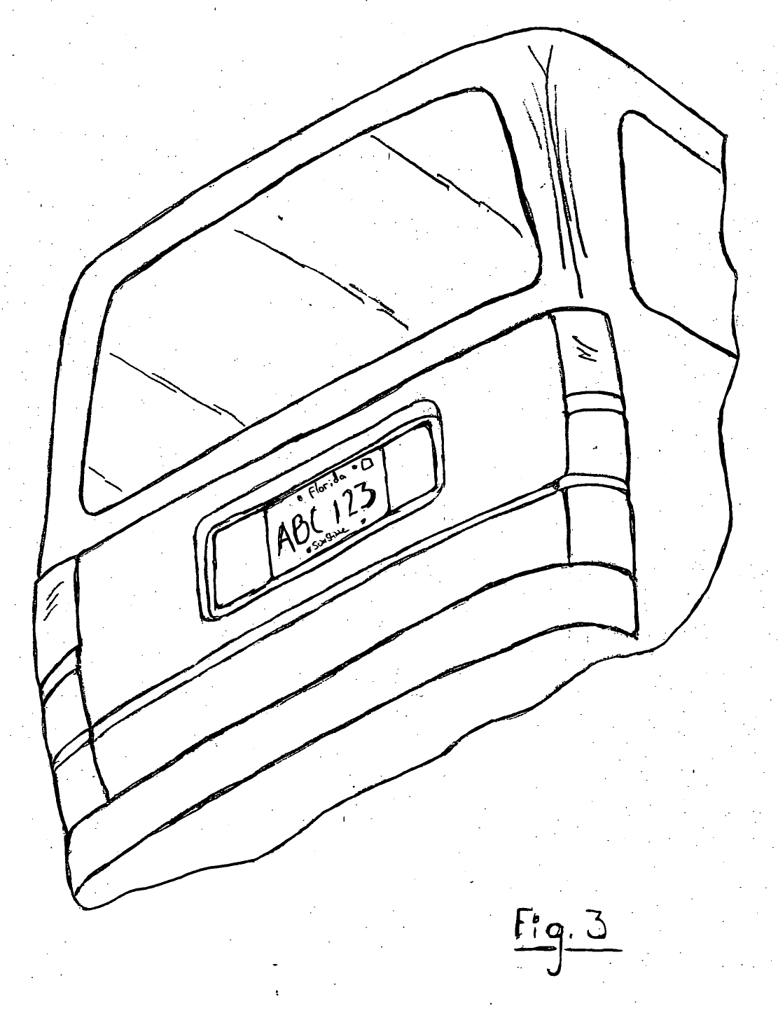

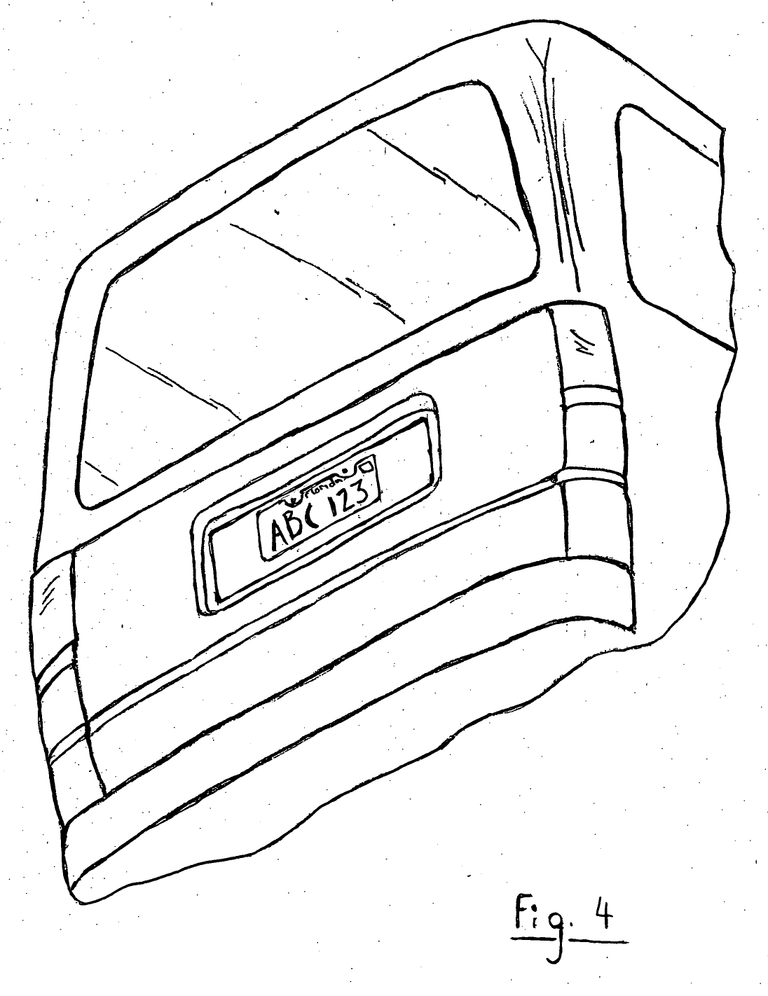

The present invention is a license plate holder comprising a generally rectangular platform that extends into the oversized license plate mount area whereupon the license plate is affixed on top of (see FIG. 3) or underneath (see FIG. 4).

While the invention has been described and pictorially shown in the accompanying drawings, it is not to be limited to such details, since any changes and modifications may be made to the invention without departing from the spirit and the scope thereof. Hence, it is described to cover any and all modifications and forms which may come within the language and scope of the claim.

1. What I claim as my invention is a device for utilizing the unused space afforded by various makes and models of vehicles that feature oversized license plate mount areas comprising;
a generally rectangular platform of predetermined size whereupon said license plate is affixed;
said platform having a substantial area whereby the user has full access to the oversized license plate mount area, providing a means for decoration.
